(19) United States
(12) Patent Application Publication
(10) Pub. No.: US 2023/0360038 A1
(43) Pub. Date: Nov. 9, 2023

(54) Method of Authentication Using Device Token

(71) Applicant: Mastercard International Incorporated, New York, NY (US)

(72) Inventors: Manu Dharmaiah Kallugudde, Maidenhead (BG); Anthony Joseph Pianezza, London (GB)

(21) Appl. No.: 18/028,177

(22) PCT Filed: Aug. 23, 2021
(86) PCT No.: PCT/US2021/047077

§ 371 Date: Mar. 23, 2023

(30) Foreign Application Priority Data
Sep. 24, 2020 (GB) 2015117.1

(51) Int. Cl. G06Q 20/38; G06Q 20/40

(52) U.S. Cl. CPC G06Q 20/3825; G06Q 20/40145

(57) ABSTRACT

The present invention discloses a method for enabling a secure data transfer comprising verifying the identity of a user having a payment device and a personal communication device; generating a payment token associated with the payment device of the user; generating a merchant device token associated with a merchant and linked to the personal communication device of the user; and processing a transaction between the user and the merchant using the payment token and the merchant device token.

### CROSS-REFERENCE TO RELATED APPLICATION

This application claims the benefit of, and priority to, United Kingdom Patent Application No. 2015117.1, filed Sep. 24, 2020. The entire disclosure of the above application is incorporated herein by reference.

### FIELD OF INVENTION

The present invention relates to a method of authentication in an online data transfer. More specifically, it relates to authenticating a merchant and a customer using a device token.

### BACKGROUND

In today's digital age, online transfer of data comprising sensitive information is common. The data may be exchanged between multiple entities and at least part of network over which the data transfer takes place may be a public network such as the internet. The trust level of such links may be less than ideal, which can enable an unauthorized party to intercept communications over these links, e.g. in a ‘man in the middle’ attack.

One example of a system where this consideration comes into play is a system that implements a payment transaction between a merchant and a customer using a payment device or card. The merchant needs to contact an authentication entity on the network to receive a token, which then acts as customer's payment credentials. The authentication entity performs the validation with an issuer and generates the token and sends the token back to the merchant. Typically, both token and dynamic data, which provides domain control and validates the merchant, are sent during authorization and verified by the authentication entity during authorization.

The customer often uses his or her personal communication device such as a smartphone to transact with the merchant. In such cases, a token generated by the merchant only ensures that the token is within the merchant domain to prevent certain fraud attacks. However, such token neither contains any consumer authentication information nor provides any authentication assurance. In other words, customer authentication is independent of tokens and tokens do not carry any authentication information about the customer or the device used by the customer to make a transaction with the merchant. In such circumstances, it is possible for a fraudster to pose as a genuine customer and perform fraudulent transactions.

Therefore, the present invention is aimed at resolving one or more of the problems mentioned above and in particular processing a transaction in a reliable and secure manner.

### SUMMARY OF THE INVENTION

According to an aspect of the invention, there is provided a method for enabling a secure data transfer comprising verifying the identity of a user having a payment device and a personal communication device; generating a payment token associated with the payment device of the user; generating a merchant device token associated with a merchant and linked to the personal communication device of the user; and processing a transaction between the user and the merchant using the payment token and the merchant device token.

Advantageously, using a merchant device token for processing a transaction provides enhanced security as both the user and the merchant can be verified irrespective of payment platform. The identity of the user is tried to the user device and even if the user is making a transaction on a desktop site, the user identify is verified on the user device to initiate transaction processing on the desktop site.

Preferably, the method includes authenticating the merchant device token and attaching the authentication information with the merchant device token.

Preferably, the method includes providing details of the payment device to the merchant before the transaction.

Preferably, the method includes directing the user to an authentication screen after the user provides the details of the payment device.

Preferably, the method includes prompting the user to enter a one-time password, received on the personal communication device from an issuer, on the authentication screen to verify the identity of the user.

Preferably, the method includes authenticating the user by a personal identification number or biometric identification on the personal communication device.

Preferably, the method includes generating a cryptogram to initiate a transaction using the payment token and the merchant device token.

Preferably, the method includes sending the cryptogram to the merchant server via another personal communication device used by the user to make a transaction with the merchant.

According to another aspect of the invention, there is provided a system comprising a payment device configured to enable a user make transactions with a merchant; a personal communication device associated with the user, wherein the personal communication device is configured to verify the identity of the user; a tokenization platform configured to generate a payment token associated with the payment device and a merchant device token associated with the merchant and linked to the personal communication device; and a merchant server configured to initiate processing of a transaction with the user using the payment token and the merchant device token.

Preferably, the merchant server is further configured to verify the identity of the user by directing the user to an authentication screen; authenticate the merchant device token and attach the authentication information to the merchant device token; and generate a cryptogram to initiate a transaction using the payment token and the merchant device token.

Preferably, the merchant server is further configured to send the cryptogram, the payment token, and the merchant device token to the merchant server via another personal communication device used by the user to make a transaction with the merchant.

Preferably, the system includes an issuer server configured to authenticate a transaction made by the user with the merchant by verifying credentials associated with the payment device.

Preferably, the payment device is a payment card with a card number, expiry date, and a security code.

According to yet another aspect of the invention, there is provided a non-transitory computer readable storage medium comprising stored instructions that when executed cause a processor to executes the steps of the method described above.

### BRIEF DESCRIPTION OF THE DRAWINGS

Embodiments of the present invention are described below, by way of example only, with reference to the accompanying drawings, in which:

FIG. 1 shows a system for authenticating a transaction between a customer and a merchant in accordance to an aspect of the invention;

FIG. 2 is a flow diagram of a method implemented in the system of FIGS. 1; and

FIG. 3 shows in schematic form a data processing device that is suitable for performing the functions of any data processing device within the system of FIG. 1.

### DETAILED DESCRIPTION

Various aspects of the invention are now described with reference to the accompanying drawings. The description and specific examples included herein are intended for purposes of illustration only and are not intended to limit the scope of the present disclosure.

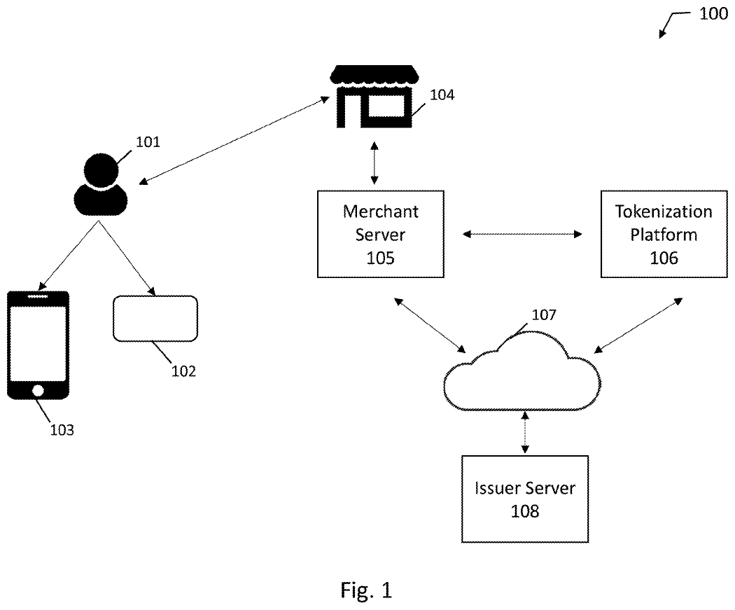

FIG. 1 shows a system 100 for implementing a process that may be utilized for authenticating and verifying a customer in connection with a transaction by the customer, and which is consistent with the EMV® 3-D Secure™ protocol/specification, for example. It should be appreciated, however, that not all details of the EMV® 3-D Secure™ protocol/specification are discussed herein, since a complete detailed disclosure of such information may be readily understood by referencing the EMV® 3-D Secure™ protocol/specification and or discussions thereof. The system 100 comprises a user 101 with a payment device 102 and a personal communication device 103, a merchant 104 associated with a merchant server 105, a tokenization platform 106, a payment network 107, and an issuer server 108. The system 100 may also include other entities such as directory servers and network peripherals which are not shown for the sake of simplicity. Various entities in the system 100 are capable of communicating with each other either wirelessly or over a wired connection. Some of the communication links may be secure while others may be unsecure public networks such as the internet.

The user 101 is associated with a payment account, where the payment account is issued to the user 101 by an issuer and is useable by the user 101 to fund purchase transactions with one or more merchants, e.g. the merchant 104. The user 101 holds the payment device 102 such as a debit/credit card issued by the issuer for making purchase transactions. The user 101 is also associated with the personal communication device 103 which is configured to access one or more virtual merchant locations. The personal computing device 103 may include, for example, a tablet, a smartphone, a laptop, a desktop, or other similar electronic device, which enables the user 101 to interact and/or communicate with the merchant 104. The payment device 102 is interchangeably referred to as a card 102 and the personal communication device 103 as a smartphone 103 hereinafter.

The smartphone 103 may include a wallet application (not shown), which is configured to provide payment account credentials for the user's payment account, for example, in connection with payment account transactions. In this embodiment, the wallet application includes a virtual wallet application, which may include, without limitation, Masterpass® from Mastercard®, Apple Pay® from Apple®, Visa Checkout®, Google Pay® from Google®, etc. Upon installation and/or activation, the wallet application, and more generally, the smartphone 103, is provided with and/or provisioned with a public/private key pair or one or more symmetric keys for use as described below, to generate cryptograms per transaction performed by the user 101 using his/her payment account (through the wallet application). The keys may be provided by a digital service server (DSS) or a payment network, e.g., payment network 107.

The merchant 104 in the system 100 preferably includes a virtual merchant having a virtual merchant location, such as, for example, a website, a network-based application, etc., which is accessible by the user 101 via the smartphone 103. The merchant virtual location may be managed and/or provided directly by the merchant 104, or by another entity on behalf of the merchant 104. The merchant 104 is connected to the merchant server 105 to process transactions with various customers such as the user 101.

In the system 100, when the user 01 browses one or more products (e.g., goods, services, etc.) at the merchant 104, via the smartphone 103, the user 101 may select to purchase a product and further provide details related to the transaction and an input at the smartphone 103 to then checkout, via a public network such as the internet. The checkout details and input, received from the user 101, may include, for example, a selection of the payment account corresponding to a token already received and stored at the merchant server 105. Alternatively, at the checkout, the user 101 provides details of the card 101 associated with a payment account. Based on that, the merchant 104 is configured to generate or request a token from the tokenization platform 106 such as Mastercard™ Digital Enablement Service (MDES) server, for example. The token is specific to the user's payment account and maps the token to a primary account number (PAN) for the payment account of the user 101. The merchant 104 then stores the token, at the merchant server 105, in association with the user's profile for later use by the user 101 in future transactions with the merchant 104 at same or other virtual location such as a desktop site instead of smartphone app.

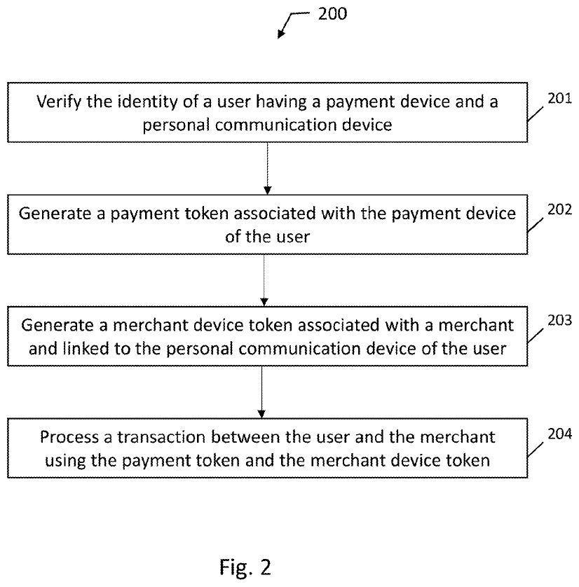

In the present invention, when the user 101 provides his or her card details to the merchant 104, as part of the tokenization process, the user 101 is required to verify his/her identity before a token is generated/activated. This is explained in detail further below with reference to FIG. 2. In addition to that, a merchant device token is generated at the merchant 104 which is authenticated by the merchant server 105 and is linked with the smartphone 103 and locked to the merchant 104. The merchant device token provides greater trust to the merchant 104 as well as the issuer as it contains information about multiple factors and is much less susceptible to an attack by a fraudster.

In one embodiment, the user 101 uses the smartphone 103 to access the merchant 104 through a merchant app. When the user 101 is ready to checkout and initiates a transaction with the merchant 104, the user 101 is asked to verify his or her identify by entering the mobile PIN or via biometrics such as touch ID or face ID. In this way, the merchant 104 is assured that it is a genuine user making a purchase. Once verified, the merchant 104 generates a cryptogram which contains all required authentication information verified in merchant domain. The merchant server 105 then passes on the cryptogram along with the token to the payment network 107 to process the transaction.

After authentication checks, the payment network 107 sends an authorization request to the issuer server 108. Then, the issuer server 108 is configured to determine if the transaction should be approved or declined, and to respond accordingly, through the payment network 107. Once a determination is made, the issuer server 104 is configured to transmit an authorization response back to the payment network 107. In turn, the payment network 107 is configured to route the authorization response to an acquirer of the merchant 104. The acquirer, in turn, is configured to provide the authorization response back to the merchant 104. The merchant 104 then provides a payment confirmation to the user 101 and prepares for the goods to be delivered.

In another embodiment, the user 101 uses a desktop site on another device to access the merchant 104. When the user 101 is ready to checkout and initiates a transaction with the merchant 104, the merchant 104 checks if the user 101 has a merchant app installed on his or her device with a token for the card 102. If so, the merchant 104 asks the user 101 to verify his or her identify on the smartphone 103 by entering the mobile PIN or via biometrics such as touch ID or face ID. After successful authentication, the merchant app generates the token and a cryptogram and sends them to the desktop site for processing the transaction. Therefore, even for desktop transactions, higher assurance is provided using multi-layer authentication and security.

FIG. 2 shows a flow diagram 200 for a method of authenticating a transaction in the system 100. It is to be noted that not all steps may be necessary performed in the same order and not all steps in the method are shown in the diagram 200. Several standard transaction processing steps performed in the system 100 are known in the art and would be understood by the skilled person.

At step 201, identity of a user having a payment device and a personal communication device is verified. In present example, when the user 101 wishes to make a transaction with the merchant 104, the merchant 104 asks the user 101 to provide details of the card 102 such as card number, expiry date, etc. Before generating a token for the card, the merchant 104 directs the user 101 to an authentication screen on the smartphone 103. On the authentication screen, the user 101 may be asked to enter some personal details and/or a one-time password (OTP) received on the smartphone 103 from the issuer. When the user 101 performs a checkout with the merchant 104 next time, the identity is verified by biometric sensing or by entering PIN on the smartphone 103.

At step 202, a payment token associated with the payment device of the user is generated. In present example, after the user details and/or OTP is verified, the merchant 104 generates a token associated with the card 102 and stores it at the merchant server 105 or in the merchant app on the smartphone 103 for future use. The token may be requested by the merchant server 105 from the tokenization platform 106. Tokenization process in well known in the art. If the user 101 is a returning customer and the token for the card 102 is already stored at the merchant server 105, then the token is retrieved or activated after the identity of the user 101 is verified on the smartphone 103.

At step 203, a merchant device token associated with a merchant and linked to the personal communication device of the user is generated. In present example, the merchant 104 generates a merchant device token which is authenticated by the merchant server 105 and the authentication information is attached to the merchant device token. The merchant device token is linked or bonded to the smartphone 103 and locked to the merchant 104. In other words, the merchant device token is a unique value specifically generated for the smartphone 103 of the user 101 and the merchant 104. By checking the merchant device token during transaction authentication, identity of both the user and the merchant can be verified with confidence. As the token is bonded to the user device such as the smartphone 103, that token cannot be used from any other device expect the verified user device. Also, as the token is locked to the merchant such as the merchant 104, that token cannot be used with any other merchant.

At step 204, a transaction between the user and the merchant is processed using the payment token and the merchant device token. In present example, when the user 101 makes a purchase using the merchant app on the smartphone 103 and proceeds with a payment for the goods purchased, the merchant 104 requests the user 101 to verify his or her identify using the smartphone 103 as described above. Once the user is authenticated, the merchant 104 initiates processing the transaction by generating a cryptogram which includes all information such as verified payment token and merchant device token. The cryptogram along with token information is passed on the payment network 107 where it is processed and the transaction is eventually approved at the issuer server 108. The use of merchant device token provides greater assurance to the issuer, thus increasing approval rates for tokens and preventing fraud attacks.

As described above, even when the user 101 makes a transaction using a desktop site, the user identity is verified on the smartphone 103 and the merchant app passes the data to the desktop site to process the transaction.

The above described method provides multi-layer security for token and token-based transactions. The user (customer) is authenticated during card addition on the merchant app and the user device is bonded to the merchant. Also, the user device is authenticated for customer validation during transaction. Both merchant domain and device are therefore restricted to ensure secure transaction.

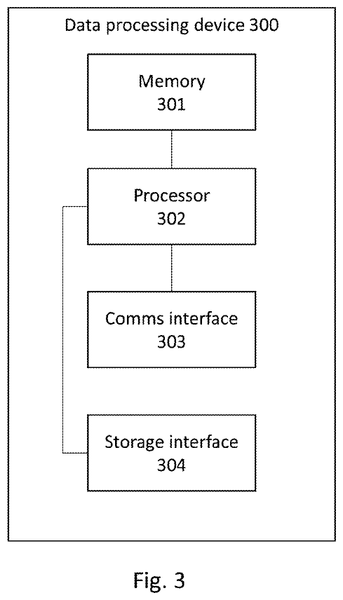

It will be appreciated that any of the methods described herein, and any particular step of said methods, can be implemented by a computer. Such implementation may take the form of a processor executing instructions stored on a non-transitory computer-readable medium or media, wherein when executed the instructions cause the processor to perform any one or more steps of any of the methods described herein. Individual steps of a method may be implemented by different processors that are all collectively acting in accordance with computer-readable instructions stored on one or more storage media. The processor or processors may be component(s) of system 100, for example a processor of the merchant server 105, the tokenization platform 106, or the issuer server 108. Equally, any steps of any of the methods described herein may be performed by data processing devices as described in respect of system 100 of FIG. 1. By way of example, FIG. 3 shows in schematic form a data processing device 300 that is suitable for performing the functions of the processing devices and servers in the system 100.

Data processing device 300 includes a processor 302 for executing instructions. Instructions may be stored in a memory 301, for example. Processor 302 may include one or more processing units (e.g., in a many-core configuration) for executing instructions.

Processor 302 is operatively coupled to a communication interface 303 such that data processing device 300 is capable of communicating with a remote device, such as another data processing device of system 100. For example, communication interface 303 may receive communications from another member of system 100 over the network, depending on the function of data processing device 300 within the context of system 100.

Processor 302 may also be operatively coupled to a storage device such as secure storage medium, depending on the function of data processing device 300 within the context of system 100. The storage device is any computer-operated hardware suitable for storing and/or retrieving data, where in the case of a secure storage medium the data is stored and retrieved securely.

Storage device can be integrated in data processing device 300, or it can be external to data processing device 300 and located remotely. For example, data processing device 300 may include one or more hard disk drives as a storage device. Alternatively, where the storage device is external to data processing device 300, it can comprise multiple storage units such as hard disks or solid state disks in a redundant array of inexpensive disks (RAID) configuration. The storage device may include a storage area network (SAN) and/or a network attached storage (NAS) system.

Processor 302 can be operatively coupled to the storage device via a storage interface 304. Storage interface 304 is any component capable of providing processor 302 with access to the storage device. Storage interface 304 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor with access to the storage device.

Memory 301 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense. While the disclosure has been described in terms of various specific embodiments, those skilled in the art will recognize that the disclosure can be practiced with modification within the scope of the claims.

As used herein, the term “non-transitory computer-readable media” is intended to be representative of any tangible computer-based device implemented in any method or technology for short-term and long-term storage of information, such as, computer-readable instructions, data structures, program modules and submodules, or other data in any device. Therefore, the methods described herein may be encoded as executable instructions embodied in a tangible, non-transitory, computer readable medium, including, without limitation, a storage device, and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and non-volatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect is enabling sensitive data such a cryptogram to be passed to the devices in a secure manner. Any such resulting program, having computer-readable code means, may be embodied or provided within one or more computer readable media, thereby making a computer program product, i.e., an article of manufacture, according to the discussed embodiments of the disclosure. The article of manufacture containing the computer code may be made and/or used by executing the code directly from one medium, by copying the code from one medium to another medium, or by transmitting the code over a network.

1. A method for enabling a secure data transfer comprising:
verifying an identity of a user having a payment device and a personal communication device;
generating a payment token associated with the payment device of the user;
generating a merchant device token associated with a merchant and linked to the personal communication device of the user; and
processing a transaction between the user and the merchant using the payment token and the merchant device token.

2. The method of claim 1, further comprising authenticating the merchant device token and attaching an authentication information with the merchant device token.

3. The method of claim 1, further comprising providing details of the payment device to the merchant before the transaction.

4. The method of claim 3, further comprising directing the user to an authentication screen after the user provides the details of the payment device.

5. The method of claim 4, further comprising prompting the user to enter a one-time password, received on the personal communication device from an issuer, on the authentication screen to verify the identity of the user.

6. The method of claim 1, further comprising authenticating the user by a personal identification number or biometric identification on the personal communication device.

7. The method of claim 1, further comprising generating a cryptogram to initiate a transaction using the payment token and the merchant device token.

8. The method of claim 7, further comprising sending the cryptogram to a merchant server via another personal communication device used by the user to make a transaction with the merchant.

9. A system comprising:
a payment device configured to enable a user make transactions with a merchant;
a personal communication device associated with the user, wherein the personal communication device is configured to verify an identity of the user;
a tokenization platform configured to generate a payment token associated with the payment device and a merchant device token associated with the merchant and linked to the personal communication device; and
a merchant server configured to initiate processing of a transaction with the user using the payment token and the merchant device token.

10. The system of claim 9, wherein the merchant server is further configured to:
verify the identity of the user by directing the user to an authentication screen;
authenticate the merchant device token and attach an authentication information to the merchant device token; and
generate a cryptogram to initiate a transaction using the payment token and the merchant device token.

11. The system of claim 10, wherein the merchant server is further configured to send the cryptogram, the payment token, and the merchant device token to the merchant server via another personal communication device used by the user to make a transaction with the merchant.

12. The system of claim 9, further comprising an issuer server configured to authenticate a transaction made by the user with the merchant by verifying credentials associated with the payment device.

13. The system of claim 9, wherein the payment device is a payment card with a card number, expiry date, and a security code.

14. A non-transitory computer readable storage medium comprising stored instructions that when executed cause a processor to executes the following steps:
verifying an identity of a user having a payment device and a personal communication device;
generating a payment token associated with the payment device of the user;
generating a merchant device token associated with a merchant and linked to the personal communication device of the user; and
processing a transaction between the user and the merchant using the payment token and the merchant device token.

15. The non-transitory computer readable storage medium of claim 14, further comprising authenticating the merchant device token and attaching an authentication information with the merchant device token.

16. The non-transitory computer readable storage medium of claim 14, further comprising providing details of the payment device to the merchant before the transaction.

17. The non-transitory computer readable storage medium of claim 16, further comprising directing the user to an authentication screen after the user provides the details of the payment device.

18. The non-transitory computer readable storage medium of claim 17, further comprising prompting the user to enter a one-time password, received on the personal communication device from an issuer, on the authentication screen to verify the identity of the user.

19. The non-transitory computer readable storage medium of claim 14, further comprising authenticating the user by a personal identification number or biometric identification on the personal communication device.

20. The non-transitory computer readable storage medium of claim 14, further comprising generating a cryptogram to initiate a transaction using the payment token and the merchant device token.
